(19) United States
(12) Patent Application Publication
(10) Pub. No.: US 2008/0125110 A1
(43) Pub. Date: May 29, 2008

(54) METHOD AND SYSTEM OF HUMAN PERCEPTION IN COMBINATION WITH MOBILE COMMUNICATIONS SYSTEMS

(75) Inventor: Rudolf Ritter, Zollikofen (CH)

Correspondence Address: PEARNE & GORDON LLP, 1801 EAST 9TH STREET, SUITE 1200, CLEVELAND, OH, 44114-3108, US

(73) Assignee: SWISSCOM MOBILE AG, Bern (CH)

(21) Appl. No.: 12/024,512

(22) Filed: Feb. 1, 2008

Related U.S. Application Data
(63) Continuation of application No. PCT/EP2006/065078, filed on Aug. 4, 2006.

(30) Foreign Application Priority Data
Aug. 4, 2005 (CH) 2005CH-1284

(51) Int. Cl. H04Q 7/20

(52) U.S. Cl. 455/424

(57) ABSTRACT

The present invention concerns a system and method for assigning a number of terms (1.4, 1.5) and objects that are on at least two levels (1.1, 1.2) on a mobile device (3) of a user. Through this knowledge, the perception of the corresponding terms and objects is additionally promoted. Thanks to the system and method described here, terms (1.4, 1.5) from different valuation levels are presented to the user who has to assign them. These terms (1.4, 1.5) can only be assigned if the user has sufficient information about the terms (1.4, 1.5). The result of the assignment product (4) is thus a measure of the knowledge of the user in question. Companies and organization can use this system and method to determine their degree of awareness and, through suitable incentives for the users, massively increase their name recognition respectively that of their products and/or services by increasing the specific perception.

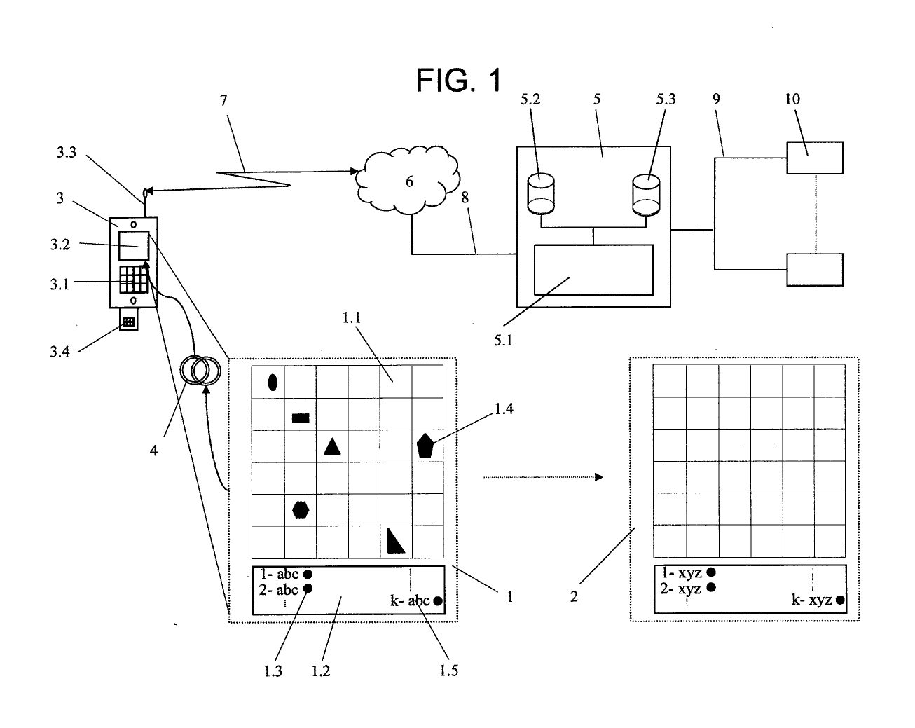

### REFERENCE DATA

The present application is a continuation of international PCT application 2006WO-EP065078 (WO07014965) filed on Aug. 4, 2006, the contents of which are hereby incorporated, and which claims priority from Swiss patent application 2005CH-1284 of Aug. 4, 2005, the contents whereof are hereby incorporated.

### TECHNICAL FIELD

The present invention relates to a system and method for detecting human perception of terms and objects in general and in combination with mobile communication in particular, in order to also promote even more, through this knowledge of the perception, the perception of the terms and objects in question.

### BACKGROUND OF THE INVENTION

Systems and methods for promoting the perception of terms and objects are known, in particular in advertising through the Internet. In particular, interactive games are already known from the prior art for increasing the degree of notoriety of products. U.S. Pat. No. 5,791,991 mentions for example a cashback bingo. WO-A1-01/23055 mentions an example of a game that functions with a number matrix, where the participant can determine a number combination and compare it with a winning combination. US-A-2002/0155878 or US-A1-2002/0183108 indicates other examples for a bingo game. US-A1-2002/0165019 discloses a bonus game. An advertising system using a mobile telephone is additionally known from patent application WO-A1-2004/049225. From broadcast systems, one knows systems that record contents in a targeted fashion on broadcast channels depending on the hearer's behavior, with additional technical means for the user.

However, no systems and methods are known that record in a targeted fashion and promote human perception to such an extent over personal communication devices, in particular mobile terminals, and thus make possible specific processes, in particular for advertising.

### REPRESENTATION OF THE INVENTION

It is an aim of the present invention to propose a system and a method that, on the basis of terminals and the infrastructure of mobile communication, makes possible the recording of human perception of terms and objects in general and in combination with mobile communication in particular.

It is a further aim of the present invention to propose a system and a method through which the knowledge of products and product providers are promoted.

It is a further aim of the present invention to propose a system and a method through which a user is specially rewarded if he can show to have special knowledge of a product or a product provider.

According to the present invention, this aim is achieved in particular through the characteristics of the independent claims. Further advantageous embodiments further arise from the dependent claims and the description.

In particular, this aim is achieved through a method for assigning terms and objects, which are on at least two levels, on a mobile device of a user, having the following method steps:

(a)the individual terms are assigned by a system provider to a level,

(b)the user establishes on his mobile device at least one assignment product of the terms and objects of a first level to the terms and objects of a second level, and

(c)the assignment product established by the user from the terms and objects of the at least two levels is transmitted from the mobile device of the user to the system provider for evaluation.

The aim is also achieved through a system with the characteristics of the independent system claim, comprising:

(a)a server and the user's mobile devices connected to the server

(b)means on the server for assigning individual terms to a level,

(c) means on the server that deliver at least two levels to the mobile device,

(d) means on the mobile device for establishing an assignment product of the terms of a first level to the terms of a second level, and

(d) means on the mobile device for transmitting the established assignment product from the terms of at least two levels from the mobile device of the user to the server for evaluation.

The above mentioned aim is achieved in particular by introducing a graphical interface for representing terms in term fields with hierarchical levels and an assignment mechanism of terms and objects from different levels. Said assignment occurs locally in the user's mobile devices set up accordingly and that transmits the assignment product generated by the corresponding user in a process-specific method to the system provider for possible further processing.

Said assignment product is for example generated in a loadable software in a mobile device of said systems or over a PDA connected over Bluetooth or another suitable technology. Depending on the subsequent development of communication systems and of the mobile terminals, other system standards can also serve as basis for this.

In another kind of embodiment, the assignment product is sent over said systems interactively from the mobile device to the system server after the user has assigned two terms.

The terms and objects in connection with the recording of perception are for example logos, word marks, brand names, product designations, sound/audio marks, texts, images, video sequences, audio files etc. Apart from these terms that relate to seeing and hearing, one can conceive of terms that relate to the sense of taste, smell and feeling as soon as these are accessible in communication systems for the users over sensors respectively generators.

In one embodiment, the assignment products are designed for regional terms, in another one for national and in yet another one for international terms of products. Inasmuch as it is useful, a mixed form of terms is also conceivable.

In a further embodiment, means are used in such a manner that the terms of the term-level can be done in the respective language of the user to allow a standardized recording of the human perception of terms and objects.

### SHORT DESCRIPTION OF THE FIGURES

The present invention is illustrated on the basis of a FIGURE, which shows diagrammatically all components of the inventive system.

### WAYS OF EXECUTING THE INVENTION

The invention relates to a method for recording human perception of terms and/or objects by assigning terms 1.4, 1.5 from two different term levels 1.1, 1.2 to one another. In the single FIGURE, a system provider 5 offers such a method for recording the human perception of terms and objects. The terms 1.4, 1.5 and/or objects are assigned to different hierarchical valuation levels and stand at least over two levels 1.1, 1.2 in an unambiguous relation to one another, so that they can be assigned to one another by a user.

The system of the single FIGURE consists of a system provider 5 administering a system server 5.1 with provider data 5.2 and user data 5.3. The server 5.1 is on the one side connected over a communication connection 9 with one or a plurality of product providers 10. On the other side, the server 5.1 is connected over a communication connection 8 with a mobile radio network 6. A plurality of mobile devices 3 are connected to the mobile radio network 6 that each belong to a user, only one mobile radio device 3 being represented in the single figure by way of example. The mobile radio devices 3 are provided with a keyboard 3.1, a display 3.2, an antenna 3.3 and a SIM card 3.4 or another identification module. In a further embodiment, it is conceivable that the mobile device 3 is a PC connected to the Internet.

In a preferred embodiment, the user establishes over his mobile device 3 and the mobile radio network 6 a connection to the system provider 5. Said mobile radio network 6 is for example a system according to the standard GSM, UMTS, Bluetooth, WLAN (e.g. standard IEEE 802.11, for instance a, b d, f, g, h) or generally according to CDMA, TDMA or OFDM (Orthogonal Frequency Division Multiplexing) or an IP network or a similar standard. The data communication between the mobile devices 3 and the system provider 5 can occur on the basis of the WAP, GPRS or a similar suitable standard. It is further conceivable that the system provider 5 is simultaneously the operator of the mobile radio network 6.

In a preferred embodiment, the device 3 consists of a personal mobile device. In another embodiment, the device 3 consists of a fixed-line device or a game console.

In a preferred embodiment, the user loads for example over his mobile device 3 from the system provider 5 a so-called client or applet, an executable software, on his mobile device 3 so that he can use the method respectively the system for recording human perception of terms and objects. Said client respectively said applet can be installed in the mobile device 3 by the user as permanent system element. As already mentioned, an embodiment is also conceivable in which the process takes place interactively from the mobile device 3 to the system provider 5. If the user is connected with the system server 5.1 over the Internet, the game can take place on an Internet page.

In a preferred embodiment, the assignment product is generated in such a manner that terms 1.5 are assigned from a subordinate level 1.2 to terms 1.4 of a superordinate level 1.1. As a general rule, there is a one-to-one relationship, which means that a term 1.5 from a subordinate level 1.2 can be assigned unequivocally to a term 1.4 of a superordinate level 1.1. In this case, the number of terms 1.4 in the higher level 1.1 is greater than that of the subordinate level 1.2, so that for example the following relation is given mathematically for the assignment:

Terms of the superordinate level (number n) Terms of the subordinate level (number k)

Combination n! * [(n−k)! * k!]⁻¹

For example, if 36 terms are listed in the superordinate level and 9 terms in the subordinate level that are to be assigned, there will be the following combination possibilities:

| n! | 3.71993E+41 |
|---|---|
| k! | 362880 |
| (n − k)! | 1.08889E+28 |
| combination n! * [(n − k)! * k!]⁻¹ | 94′143′280 |

This assignment number is much higher for example than that of a lottery (in the Swiss lottery, 6 numbers out of 45 mean a combination 8'145'060), which is why the correct assignment of all 9 terms in this example of the lower level 1.2 to the higher level 1.1 can be achieved normally only through knowledge of the matching of the terms. The knowledge of the correct matching is the measure of the perception, thus the perception can be determined through the matching of terms according to the method represented above.

Generally, the set n respectively k can be a subset of large set that is selected by the system provider 5. With this method, the combination indicated above for the assignment of the terms 1.4, 1.5 can be increased by a multiple. Thus, it is basically possible to assemble and make available upon request by the user a new basic set for generating the combination for each user.

The terms 1.4, 1.5 and objects in connection with the recording of perception are for example logos, word marks, brand names, product designations, sound/audio marks, texts, images, video sequences, audio files etc. Apart from these terms that relate to seeing and hearing, one can conceive of terms 1.4, 1.5 that relate to the sense of taste, smell and feeling as soon as these are accessible in communication systems for the users over sensors respectively generators. In one embodiment, the assignment products 4 are designed for regional terms, in another one for national and in yet another one for international terms of products. Inasmuch as it is useful, a mixed form of terms is also conceivable.

In a first step, the system provider records the data 5.2 of product providers 10 and the data of the users 5.3. He then assigns in the system server 5.1 the individual terms 1.4, 1.5 each to one level 1.1, 1.2 and supplies the at least two levels 1.1, 1.2 to the mobile device 3 of one or several users. Since the product providers 10 are advertised, they pay the system provider 5 a fee for using this service. This fee can for example depend on the number of terms of the product provider 10.

The system provider 5 then receives one or several assignment products 4 in return from the user. The system provider 5 will of course make said assignment products 4 available to the product providers 10 or to other persons for further evaluation.

As the mobile user usually has an account over which he is billed for use of the mobile device (telephone calls, SSMS, GPRS connection etc.), he can receive a credit on this account if the assignment is successful. He can also receive special rates for using the telephone services if he has generated a correct assignment product. Such a reward is in particular possible if the system provider 5 is the mobile radio operator. The system provider can also transmit the data to the mobile radio operator. It is also conceivable that the user receives a message from a product provider 10 with a voucher for a reduction of a product. This can be for example in the form of an SMS or MMS. As the user knows the product provider, he must still be informed where and how he can redeem the voucher. One possibility is that the mobile user receives an individual code he can indicate on an Internet page or in a shop and thus redeems the voucher.

In one variant embodiment, the user can chose from which topics he wishes to receive terms, since a plurality of product providers 10 will be connected. In this manner, it is possible to ensure that he receives information from car and electronics manufacturers whilst he is not interested in gardening equipment. Additionally, he could receive advertising from the product providers 10 since the latter know the user's main centers of interest.

In order to activate the game, the user can for example switch to the mode represented with the mobile device display 3.1 through a menu, not represented in the FIGURE. In this mode, the user is offered at least two term fields of one of the levels 1.1 and of one of the levels 1.2 to generate the assignment product 4. A larger number of levels 1.1, 1.2 whose terms are to be assigned to each other is of course possible within the frame of the invention. In the term fields of the level 1.1 terms 1.4 are represented that are for example such as logos, word marks, brand names, product designations, sound/audio marks, texts, images, video sequences, audio files etc.

In the term field of the level 1.2, terms 1.5 are listed that can be assigned to one of the terms 1.4 of the level 1.1 and that can for example also be such as logos, word marks, brand names, product designations, sound/audio marks, texts, images, video sequences, audio files etc. The number n of terms 1.4 of the superordinate level 1.1 is as a general rule higher than the number k of the terms 1.5 of the subordinate level 1.2.

It is also conceivable that a superordinate level 1.1. only receives the names, the logo or a word mark of product providers whilst a subordinate level 1.2 are logos, word marks, brand names, product designations, sound/audio marks, texts, images, video sequences, audio files etc. that come from said product providers mentioned under 1.1, are offered by them and to be assigned to them.

In the process, the system provider 5 establishes for the user that is calling up over hiss mobile device 3 a set of terms 1.4, 1.5 an individual set for the terms 1.4 of the term level 1.1 and the terms 1.5 of the term level 1.2. This set can be the same for all users in one variant embodiment of the inventive game.

In a preferred embodiment, the user can, by navigating on the individual terms 1.4 of the higher valuation, retrieve additional information about the specific term. If the term 1.4 is for example the logo of a company, the user can retrieve for his information specific information about this company or its products, which can be of any kind. It is also possible to retrieve information of any kind to the terms 1.5 of the superordinate level 1.2 that are to be assigned to the terms 1.4 of the subordinate level 1.1.

Additionally to the term fields of the levels 1.1, 1.2 represented in the FIGURE, additional function symbols can be arranged depending on the embodiment. For the assignment of the terms 1.4, 1.5, several methods are possible, for example graphical by marking the corresponding terms or for example through alphanumerically entering the terms to be assigned, for example the kind (11, 6), which means that the term 6 of the level 1.2 is to be assigned to the term 11 of the level 1.1. Once all the values of a set of terms 1.4, 1.5 are assigned to each other, the assignment product 4 is generated and is addressed to the system provider 5.

In the case of an interactive variant, an assignment product 4 consists for example of individual terms 1.4, 1.5 of the level 1.1, 1.2. The delivery of the assignment product 4 occurs automatically after generation or activation by the user of the corresponding function symbol in the activation field 1.2.

As previously mentioned, the individual terms 1.4, 1.5 are grouped in a number of levels 1.1, 1.2 with each n, k terms, where the subordinate terms can be assigned to the superordinate ones. The terms n, k selected by the system provider 5 can be a subset of a larger set. Concretely, this means for example the following: from any set of terms 1.4, 1.5 that are recorded at the system provider 5 by the product providers 10, 36 are represented on the mobile device display 1 as terms 1.5. For each term 1.4 of the level 1.1, any set of assignable terms 1.5 of the level 1.2 is recorded at the system provider 5 by the product providers 10 and one assignable term 1.5 is displayed at a time in the term field of the level 1.1. In the mobile device display 1, 2, only one subset of possible and assignable terms 1.4, 1.5 of the levels 1.1, 1.2 is represented in one representation. On the basis of these assignment mechanisms, it is possible for example to dynamically supply each user with another combination to assign and the number of combinations increases by a multiple of the previously represented example with 9 term values, level 1.2, to 36 term values, level 1.1.

In one embodiment, in the case of multiple querying of assignable terms 1.4, 1.5 by the same user, a different combination of terms of the levels 1.1, 1.2 is supplied in a controlled fashion to the user that are for example based on the MSISDN (Mobile Station Integrated Services Digital Network), the IMEI (International Mobile Equipment Identity), the IMSI (International Mobile Subscriber Identity), a system password or another user recognition. This has the advantage that a user can participate as often as he wishes to the recording of human perception of terms and objects and it is possible in this case to supply him with different terms of the levels 1.1, 1.2.

In another embodiment, the combination of terms of the levels n, k supplied to the user is provided with a so-called “timeout” that ensures that the assignment product 4 to be generated for the supplied combination must be delivered to the system provider 5 within a maximum period of time.

In a further embodiment, means are used in such a way that the terms 1.4, 1.5 of the levels 1.1, 1.2 can be executed for a uniform recording of the human perception of terms and objects in the user's own language.

In a further preferred embodiment, several combinations of terms 1.4, 1.5 of the levels 1.1, 1.2 can be supplied for generating assignment products 4 for recording the human perception of terms and objects on the mobile device 3 of the system provider 5, which is represented in the FIGURE with two displays 1, 2. The user thus has to generate and send to the system provider 5 several term-assignment products 4 of terms 1.4, 1.5 of the levels 1.1, 1.2. With the combinations for recording the terms of the levels 1.1, 1.2 indicated above, the level of difficulty for determining the perception can be set arbitrarily for the user.

As previously mentioned, the user can, by navigating on the individual terms 1.4 of the higher valuation, for example retrieve additional information about the specific term. In a further variant, mechanisms are made available to the user with which he can also trigger orders for products of any kind, if the term is for example a provider 10 of a particular product that is in connection with the terms 1.4, 1.5 of the levels 1.1, 1.2.

The invention allows a wide recording of advertising effects and at the same time a wide stimulation of advertising over mobile communication, in particular mobile devices. Any number of product providers 10 can register with the system provider 5 and make available their products together with their logos, which are used as terms 1.4, 1.5, over the system provider 5 to the users for recording the perception for example of company and product. The representation of logos and products is such that an assignment of company respectively logo with the corresponding product is possible as a rule only if the user has a certain knowledge. Thanks to the special arrangement and evaluation, a random assignment will never result in a perception that yields a good result for the provider and for the active user. With the corresponding combinations, it is possible to control the level of difficulty of the recording for the users.

The result of the assignment product is thus a measure of the knowledge of the user in question. Companies and organization can use this system and method to determine their degree of awareness and, through suitable incentives for the users, massively increase their name recognition respectively that of their products and/or services by increasing the specific perception. The present invention can thus have considerable commercial importance for companies and organizations.

Because in most countries, in particular in the European countries, user penetration of mobile systems is way over 80%, advertising over the mobile thermals 3 according to the system and method described here has enormous reach, i.e. mobile communication users that are at the same time potential customers of the product providers 10, can be reached everywhere and at any time. Unlike outside advertising with posters, it is possible with the system and method presented here one the one hand to record and on the other hand, with suitable incentives for the users, increase the perception of companies and their products, the effort required by comparison with outside advertising in particular and advertising in general being considerably lower and the application much more flexible.

### LIST OF REFERENCES

1 Mobile device display
1.1 First level
1.2 Second level
1.3 Activation field
1.4 Terms of the first level 1.1
1.5 Terms of the second level 1.2
2 Mobile device display
3 Mobile device
3.1 Keyboard
3.2 Display
3.3 Antenna
3.4 SIM card
4 Assignment product
5 System provider
5.1 System server
5.2 Data of the product provider 10
5.3 User data
6 Mobile communication system
7 Wireless interface
8 Communication system
9 Communication connection
10 Product provider

1. Method for assigning terms and objects, which are on at least two levels, on a mobile device of a user, having the following method steps:
(a) the individual terms are assigned by a system provider to a level and the at least two levels are delivered to the mobile device,
(b) the user establishes on his mobile device at least one assignment product of the terms and objects of a first level to the terms and objects of a second level, and
(c) the assignment product established by the user from the terms and objects of the at least two levels is transmitted from the mobile device of the user to the system provider for evaluation.

2. The method of claim 1, wherein the mobile device is connected over a mobile radio network and/or the Internet with the server of the system provider.

3. The method of claim 1, wherein the user loads on his mobile device an applet or an executable software that communicates with the system provider and receives the terms and delivers the generated assignment product to the system provider.

4. The method of claim 1, wherein the user chooses from which topic he wishes to receive terms.

5. The method of claim 1, wherein the method occurs interactively and an assignment product of a single assignment from a term of one level with a term of another level is transmitted to the system provider for evaluation.

6. The method of claim 1, wherein the number of terms of the different levels is different.

7. The method of claim 1, wherein the terms of at least two levels are selected by the system provider as subset from a set, each containing a similarly large number of terms.

8. The method of claim 1, wherein the individual terms are selected and assigned user-specifically by a system provider each from one level and delivered to the mobile device of the individual user.

9. The method of claim 1, wherein in a recording process for generating the assignment products a timeout is used for limiting the recording time.

10. The method of claim 1, wherein the terms concern logos, word marks, brand names, product designations, sound/audio marks, texts, images, video sequences, audio files and terms from this realm of senses.

11. The method of claim 1, wherein the terms include regional, national and/or international product terms.

12. The method of claim 1, wherein the product provider registers with the system provider and supplies terms to a system provider.

13. The method of claim 1, wherein after a successful assignment product, the user receives a voucher for a price reduction for a product of a product provider.

14. The method of claim 1, wherein the user receives a voucher from a billing account of the mobile device or special conditions for using the mobile device.

15. The method of claim 1, wherein the user receives advertising from at least one product provider.

16. The method of claim 1, wherein the terms of the levels are indicated in the user's own language.

17. The method of claim 1, wherein users can retrieve additional information about the terms of the levels.

18. The method of claim 1, wherein users can trigger orders in connection with the terms of the levels.

19. The method of claim 1, wherein in the case of multiple querying of assignable terms by the same user, a different combination of terms of the levels is supplied to the user.

20. The method of claim 1, wherein the mobile device is provided with an identification module and has a MSISDN, an IMEI and an IMSI, the IMEI, the IMSI of the mobile device, a system password or another user recognition for establishing and evaluating the assignment products.

21. A system for executing the method of claim 1, comprising:
(a) a server and the users' mobile devices connected to the server,
(b) means on the server for assigning individual terms to a level,
(c) means on the server that deliver at least two levels with assigned terms to a mobile device,
(d) means on the mobile device for establishing an assignment product of the terms of a first level to the terms of a second level, and
(d) means on the mobile device for transmitting the established assignment product from the terms of at least two levels from the mobile device of the user to the server for evaluation.

22. The system of claim 21, wherein the means on the mobile device for generating an assignment product from the terms of a first level to the terms of a second level is a software in the form of a client or applet.

23. The system of claim 21, wherein the means for generating the assignment product for the mobile devices are interactive with the server of the system provider.

24. The system of claim 21, wherein the mobile device is connected over a mobile radio network and/or the Internet with the server.

25. The system of claim 21, wherein the mobile devices are mobile telephones that communicate with a GSM network, UMTS network or WLAN.

26. The system of claim 21, wherein the terms concern logos, word marks, brand names, product designations, sound/audio marks, texts, images, video sequences, audio files and terms from this realm of senses.

27. The system of claim 21, wherein the terms include regional, national and/or international product terms.

28. The system of claim 21, wherein the product provider registers with the system provider and supplies terms to a system provider.

29. The system of claim 21, wherein means are provided in the mobile device for retrieving additional information about represented terms of the levels and for triggering product orders.

30. The system of claim 21, wherein the server has means for indicating the terms of the levels in the user's own language.
